(19) United States
(12) Patent Application Publication
(10) Pub. No.: US 2019/0184887 A1
(43) Pub. Date: Jun. 20, 2019

(54) INVENTORY SAFETY RESTRAINT

(71) Applicants: Frank Elardi, Jackson, NJ (US); Steven Casalino, Hallandale Beach, FL (US)

(72) Inventors: Frank Elardi, Jackson, NJ (US); Steven Casalino, Hallandale Beach, FL (US)

(21) Appl. No.: 16/222,228

(22) Filed: Dec. 17, 2018

Related U.S. Application Data
(60) Provisional application No. 62/607,014, filed on Dec. 18, 2017.

(51) Int. Cl. B60P 7/14; B60P 7/08; A47B 97/00

(52) U.S. Cl. CPC B60P 7/14; A47B 97/00; B60P 7/0876

(57) ABSTRACT

A retractable safety restraint device includes an inner core, a spring disposed around the inner core and having a relaxed condition and an stretched condition, an outer shaft disposed around the spring, a housing disposed around the outer shaft, the outer shaft being rotatable within the housing, a moveable member translatable relative to the housing, and a body coupled to the outer shaft at a first end, and to the moveable member at a second end, the body having a length from the first end to the second end, and a width perpendicular to its length, the width of the body being approximately equal to a height of the housing, the body being wrapped around the outer shaft when the spring is in the relaxed condition.

### CROSS-REFERENCE TO RELATED APPLICATIONS

This application claims priority to U.S. Provisional Application Ser. No. 62/607,014, entitled “INVENTORY SAFETY RESTRAINT,” filed Dec. 18, 2017, which is incorporated by reference herein in its entirety.

### FIELD OF THE DISCLOSURE

The present disclosure relates to safety restraints for use with merchandise. More particularly the present disclosure relates to safety restraints for use within truck storage compartments and store shelving.

### BACKGROUND OF THE DISCLOSURE

Transporting inventory in trucks is difficult as merchandise tends to shift during travel. For example, boxes of items may be neatly stacked on top of one another when loaded into a truck storage compartment, but begin to shift as a truck turns or hits bumps along the road. It is then difficult to unload these boxes or items without damage. Additionally, certain items may break or become contaminated during shipping. The movement of items also presents a danger to employees during unloading, as items may become unstable and fall on the employees, or fall to the ground and become a tripping hazard.

Similar problems are also prevalent in the retail industry where items are often stacked on shelving. In certain instances, items tend to fall from the shelves and injure customers or employees. For example, stacked items may become unstable when one item is removed, and the remaining stack may fall on a customer or employee at a later time.

Ropes and other solutions have been used but they can become entangled. Additionally, it is often too cumbersome and too time-consuming to secure items with rope and to untie knots each time to release the merchandise. Rope is also often too thin and flimsy to properly secure large items. Thus, it would be beneficial to provide a safety restraint system to be used during shipping and storage to keep merchandise secured, and reduce the risk of harm to employees and the public.

### SUMMARY OF THE DISCLOSURE

In some embodiments, a safety restraint device includes an inner core, a spring disposed around the inner core and having a relaxed condition and an stretched condition, an outer shaft disposed around the spring, a housing disposed around the outer shaft, the outer shaft being rotatable within the housing, a moveable member translatable relative to the housing, and a body coupled to the outer shaft at a first end, and to the moveable member at a second end, the body having a length from the first end to the second end, and a width perpendicular to its length, the width of the body being approximately equal to a height of the housing, the body being wrapped around the outer shaft when the spring is in the relaxed condition.

In some embodiments, a transportation system includes a storage compartment, and a safety restraint device including an inner core, a spring disposed around the core and having a relaxed condition and an stretched condition, an outer shaft disposed around the spring, a housing disposed around the outer shaft, the outer shaft being rotatable within the housing, a moveable member translatable relative to the housing, and a body coupled to the outer shaft at a first end, and to the moveable member at a second end, the body having a length from the first end to the second end, and a width perpendicular to its length, the width of the body being approximately equal to a height of the housing, the body being wrapped around the outer shaft when the spring is in the relaxed condition.

### BRIEF DESCRIPTION OF THE DISCLOSURE

Various embodiments of the presently disclosed connectors are disclosed herein with reference to the drawings, wherein:

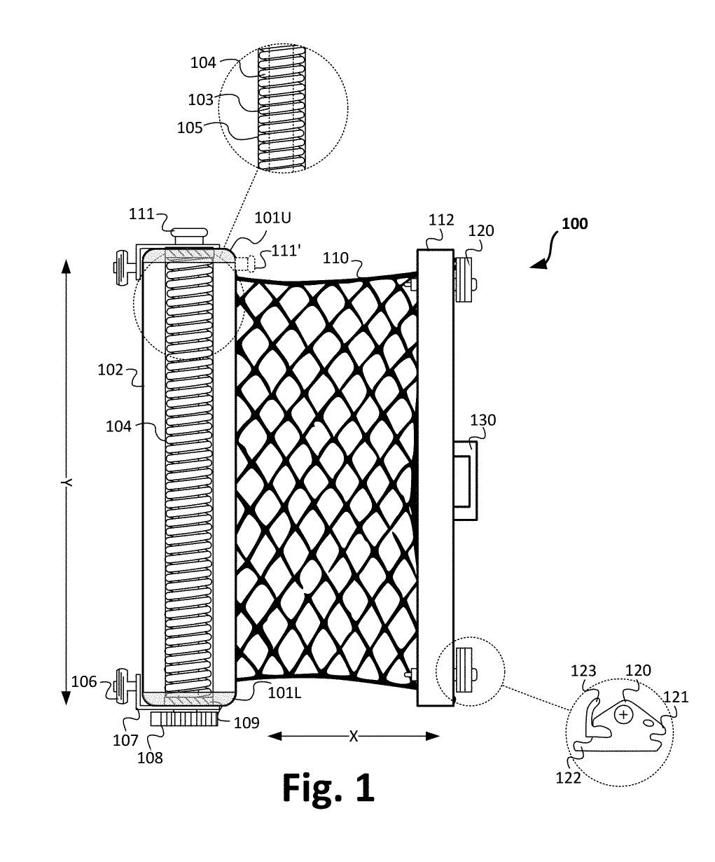

FIG. 1 is a schematic side view of a safety restraint system in a partially extended condition;

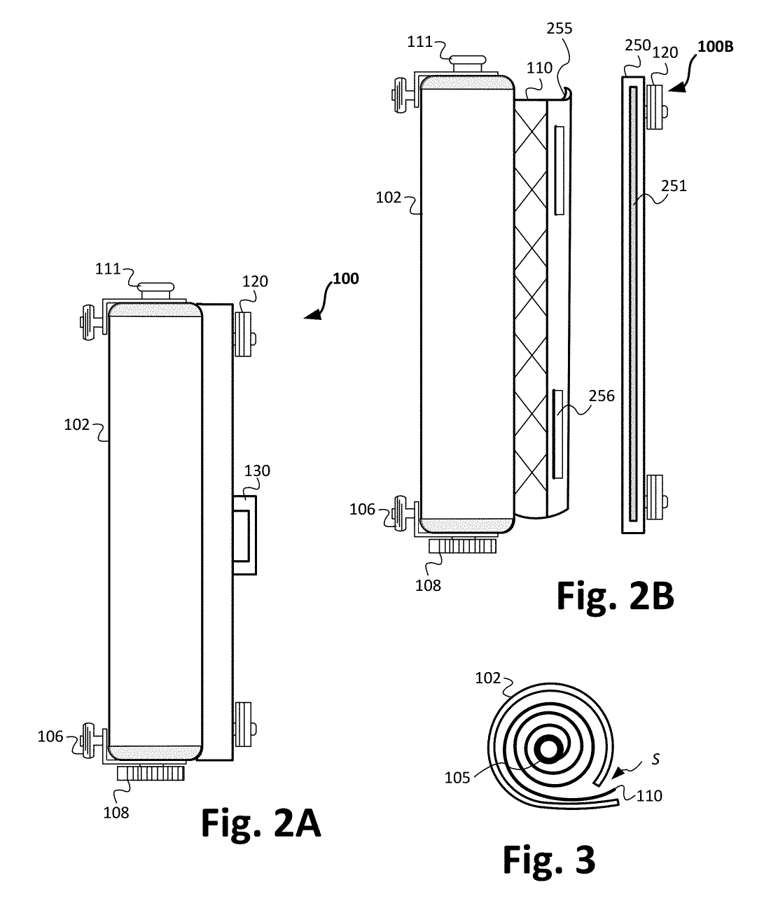

FIG. 2A is schematic side view of a retractable safety restraint system in a fully closed and retracted condition;

FIG. 2B is a schematic side view of another variation of a retractable safety restraint system;

FIG. 3 is a schematic top view showing a net coiled around an outer shaft;

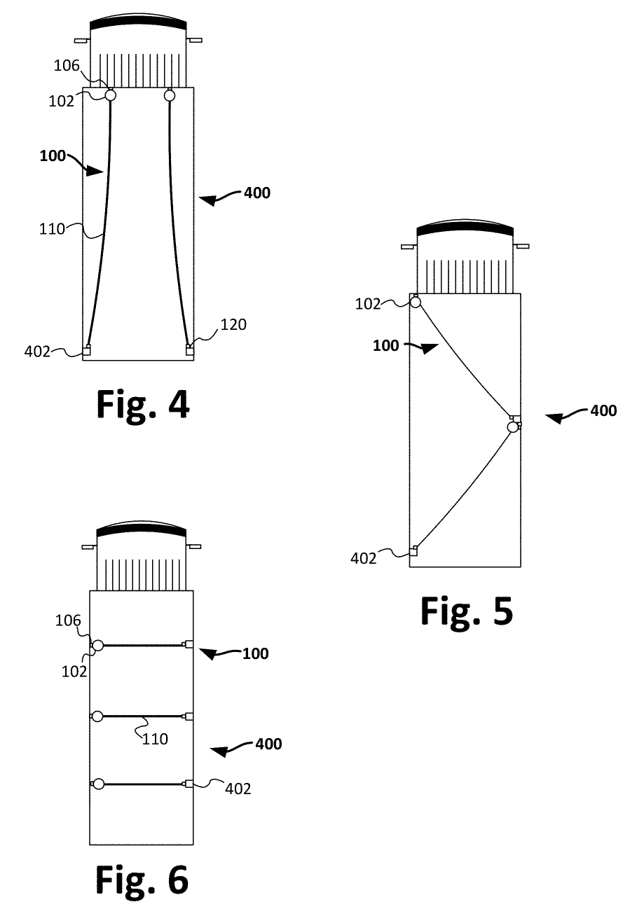

FIGS. 4-6 are schematic top views of trucks having a storage compartments utilizing the safety restraint systems in various configurations;

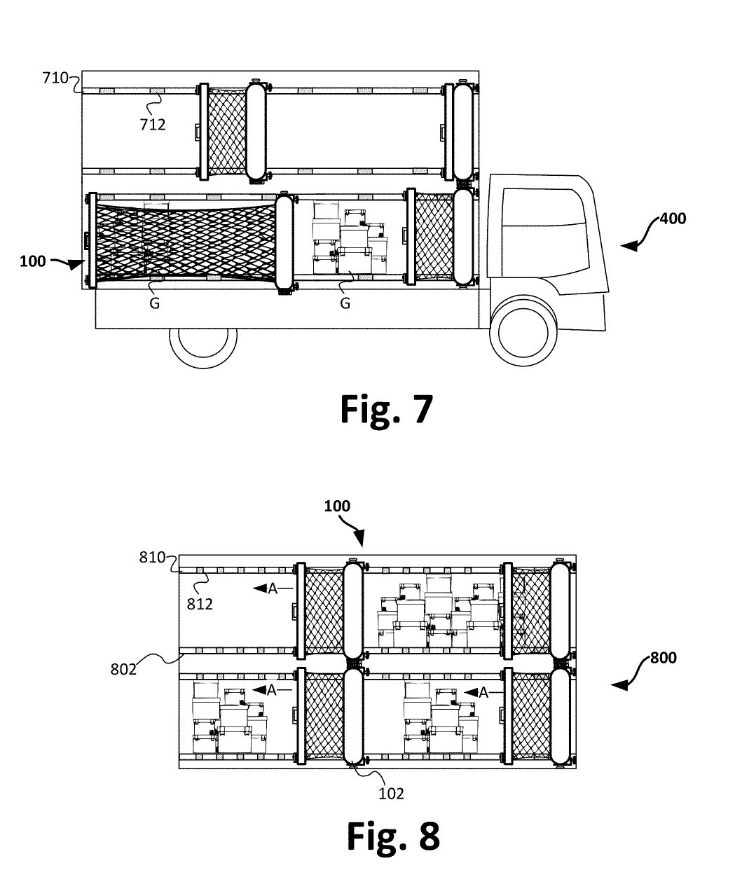

FIG. 7 is a schematic side view showing a truck having tracks for use with one embodiment of a safety restraint system; and

FIG. 8 is a schematic front view of a store shelving area that utilizes one embodiment of the safety restraint system according to the present disclosure.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to shipping and storage solutions, conventional methods suffer from some shortcomings as discussed above.

There therefore is a need for further improvements to the devices and methods of safely shipping, storing and displaying inventory items, merchandise, products, boxes, tools and other items that would benefit from being more safely handled. Among other advantages, the present disclosure may address one or more of these needs.

FIG. 1 illustrates a retractable safety restraint device 100 that is useful for securing inventory items. As seen in FIG. 1, safety restraint device 100 includes an elongated substantially cylindrical housing 102 extending between an upper end cap 101U and a lower end cap 101L. Housing 102 may be formed of a material having a metal, a plastic and/or wood. For example, housing 102 may be formed of a PVC pipe. Inside the housing, and extending from one end of the housing to the other (e.g., between the two end caps 101U,101L) is an inner core 103. Upper and lower end caps 101U,101L may include recesses for receiving portions of inner core 103. A spring 104 is disposed around inner core 103 and disposed in a concentric arrangement therewith. Spring 104 may extend along a longitudinal axis “Y” that is parallel with the longitudinal axis of the housing 102 and may have a relaxed condition when no force is applied thereto and a stretched condition when a force is applied thereto. An elongated hollow outer shaft 105 may be disposed over and around both spring 104 and inner core 103 to house the two components therein. Moreover, outer shaft 105 may be coupled at one or both ends to gears 109, and may be rotatable relative to the inner core. In some examples, spring 104 may also be directly coupled to gears 109 or to a portion of outer shaft 105. Briefly, when gears 109 are rotated in a first direction, outer shaft 105 turns with it as well as spring 104, the turning of the spring causing it to go from the relaxed condition to a stretched condition. In the stretched condition, potential energy is stored within spring 104 so that when no force is applied thereto, spring 104 will turn in a second direction, opposite the first direction.

Two clamps 106 are attached to L-shaped brackets 107, which in turn are attached to housing 102. In some examples, each clamp 106 is in the form of an E-clip to be used with an E-track system that is attached to a truck's inner walls. It will be understood that in some examples, only one clamp 106 may be used, and that clamps 106 may be directly coupled to housing 102 instead of being attached via brackets 107. Clamps 106 may serve to fix housing 102 in a certain location within the storage compartment (e.g., maintain housing 102 in a position against a wall).

A rotatable wheel 108 may be disposed adjacent lower cap 101L and operatively coupled to one of gears 109, which in turn is coupled to outer shaft 105. Wheel 108 may include indentations so that it is easily manipulated by a user. On the opposite side of housing 102, adjacent upper cap 101U and across from wheel 108 is locking pin 111. In some embodiments, one of gears 109 includes one or more holes disposed around its circumference and locking pin 111 may be pressed into a hole of the gear to prevent any rotation of outer shaft 105 relative to housing 102. As shown in this example, locking pin 111 is disposed above the upper cap 101U and extends in the vertical direction (Y-direction). Alternatively, locking pin 111′ may be disposed horizontally and extend in the X-direction through an opening in housing 102. Such a locking pin 111′ may be disposed anywhere on the circumference of housing 102 (e.g., on one side as shown in phantom lines, or on the opposite side, closer to clamps 106.

An extendable and retractable body 110 is coupled at one end to outer shaft 105 and at an opposing end to moveable member 112. Body 110 may be formed of netting and may include rope, thread, twine, nylon strands or other strings that are interwoven together to form a body having a plurality of apertures as shown. Suitable materials for body 110 may include yarn, fabric, nylon, rope, metal wire, or any suitable combination thereof. Alternatively, body 110 may be formed of a canvas or other sheet including or not including apertures, instead of a conventional netting. Body 110 may also be translucent so that merchandise is clearly visible when secured behind the body. Body 110 may be capable of wrapping around outer shaft 105 and being retracted and entirely disposed within housing 102 when the device 100 is in the entirely closed or retracted configuration. Additionally, as shown, body 110 may include a first group of filaments traveling in a first direction, and a second group of filaments that cross the first group of filaments. In at least some embodiments, the first group and the second group of filaments are perpendicular. Alternatively, the groupings may cross one another to form diamond-shaped apertures as shown.

Moveable member 112 may be formed of a metal, plastic or other suitable material (e.g., any material similar to that of housing 102, such as a pvc pipe) and as discussed above, is coupled to one end of the body 110 so that body 110 is stretchable between moveable member 112 and housing 102 and is extendable in the direction “X”. Two connectors 120 are coupled near opposing ends of moveable members, and a handle 130 is disposed approximately halfway between the two connectors 120. It will be understood that any number of connectors 120 may be disposed on moveable member 112, including a single connector or three or more connectors. In some examples, connectors 120 are in the form of E-clips as shown to be used with an E-track system. In this example, connector 120 includes a first end 121 that falls into an aperture of the track system, a second end 122 opposite the first end, and a pivoting locking arm 123. Each connector 120 may be aligned with a top and a bottom of the housing and may be equally spaced from handle 130.

In one variation (FIG. 2B), device 100B is substantially similar to device 100 except that it includes a quick-connect system in the form of connectors 120 being affixed or otherwise coupled to an elongated receiving track 250 having an elongated slot 251. Body 110 may be coupled to an elongated hooking member 255 in the shape of either an S-shaped member, a C-shaped member or other shape that is suitable for coupling to elongated slot 251 of receiving track 250. Hooking member 255 may include one or more handles 256 for pulling the body out of the housing. In this embodiment, receiving track 250 may be coupled to the track system of the truck, and the hook-shaped member 255 may be coupled to or released from the elongated slot 251 of receiving track 250 as needed. Thus, instead of repeatedly coupling and decoupling connectors 120 (e.g., E-clips) from the track system of the truck, the user may keep the connectors 120 affixed to the track at all times and quickly couple/decouple hooking member 255 from elongated slot 251, which is easier to use.

Safety restraint device 100 may include a fully retracted condition, a fully expanded condition, and a number of partially expanded conditions between the fully expanded and the fully retracted conditions. A partially expanded condition is shown in FIG. 1. In the fully expanded condition of the device, spring 104 may be in its stretched condition, and body 110 may span a distance between the housing and the moveable member of approximately 2 feet to 60 feet (in the x-direction of FIG. 1) depending on the length of the body 110 and/or the length of the truck in which the device will be used, and may be between 12 inches to 36 inches in width (the y-direction of FIG. 1). As shown in the partially expanded condition of FIG. 1, body 110 spans a distance between the housing and the moveable member of approximately 2 feet, while the width of the body remains at 3 feet, or approximately equal to the height of the housing. In at least some examples, the span of the body is approximately equal to the length of a truck storage compartment and the width of the body is approximately equal to the height of a storage compartment.

As shown in FIGS. 2A, 2B and 3, body 110 may be rolled onto outer shaft 105 so that, when retracted, the body is almost entirely disposed within housing 102, the spring 104 now being in the relaxed condition. When the user pulls on handle 130 of moveable member 112, body 110 may be continuously pulled out of elongated slit “S” of housing 102 so that body unravels from the outer shaft until the appropriate amount of body (e.g., netting) is available to secure the merchandise (FIG. 3). When the user has obtained enough length of body 110 from the housing, he may actuate wheel 108 to provide additional tension in body 110 by rolling more of body 110 onto outer shaft 105 (i.e., to provide a fine adjustment to the length of body 110 so that body 110 firmly presses against the merchandise). The user may then depress locking pin 111 into housing 102 to lock this length. With locking pin 111 depressed, rotation of outer shaft 105 is not possible so that the span of body 110 (e.g., the distance between the housing and the moveable member) is fixed until the locking pin is released.

When the user wishes to remove the device, he may simply release locking pin 111 to allow the gears to turn. With no external force applied to the system, spring 104 will return to its relaxed state, pulling body 110 into housing 102 to wrap around outer shaft 105 as the user guides the body gently into the housing by holding handle 130. It will be understood that the diameter of housing 102 will be proportional to the length of the body. For example, a 60-foot body will require a relatively larger housing, while a 3-foot body will require a relatively smaller housing. In at least some examples, housing 102 has a diameter of between 6 inches and 18 inches. In at least some examples, housing 102 has a diameter of approximately 12 inches.

FIGS. 4-6 illustrate various configurations in which safety restraint device may be arranged to secure products or goods in a truck storage compartment 400. For example, in FIG. 4, two safety restraint devices 100 extend substantially longitudinally from one end of the storage compartment 400 to the other. Clamps 106 couple housing 102 to one end of the storage compartment. Additionally, connector receiving apertures 402 are disposed along the walls of the storage compartment and are configured to mate with connectors 120 of device 100 so that body 110 stretches between the clamp 106 and the connector 120. In an alternative embodiment, safety restraint devices 100 are diagonally disposed within storage compartment 400 as shown in FIG. 5. In an additional embodiment, one, two, three, four or more safety restraint devices 100 are disposed across storage compartment 400 (e.g., extending between the sidewalls) as shown in FIG. 6.

FIG. 7 illustrates another embodiment, wherein a storage compartment 400 includes a number of tracks 710 coupled to the sidewalls of the compartment, each track having a number of apertures 712. In this example, four safety restraint devices are disposed within the storage compartment, each safety restraint device being aligned with a pair of tracks 710 so that connectors 120 and clamps 106 of device 100 are coupleable to the apertures of the track. Upper and lower pairs of tracks are provided so that two levels of safety restraint devices may be used. Additionally, in this example, each level includes two safety restraint devices. It will be understood that each level may instead include a single safety restraint device extending along the entire length of the storage compartment, or each level may include more than two devices (e.g., three or four devices on each level). In this illustration a single safety restraint device is fully extended over goods “G”, while two safety restraint devices are partially extended, and one safety restraint device is fully retracted. With the body 110 of safety restraint device 100 covering goods “G” and holding the goods against the wall of the storage compartment, the items may be secured against the wall of the storage compartment and prevented from sliding or falling during transportation. This reduces the risk of damage to the goods, and the risk of injury to employees. When the goods arrive at their intended location, the user may release the locking pin and decouple connectors 120 from the apertures 712 of track 710. The spring 104 will then be capable of returning to its relaxed configuration, rotating outer shaft 105, and pulling body 110 within housing 102 and wrapping it around outer shaft 105. Goods may then be removed from the storage compartment.

The safety restraint device may also be used in warehouses and retail stores to ensure that items do not become damaged or injure customers and/or employees. FIG. 8 illustrates one embodiment of the present disclosure in which a store aisle 800 includes two levels of shelving 802. As shown, each level of shelving includes upper and lower tracks 810, each track having a plurality of apertures 812 for coupling to clamps and/or connectors of safety restraining device 100. Thus, merchandise may be secured with body 110 of safety restraint device 100. Additionally, because body 110 may be formed of a netting or translucent material, customers may easily see the items behind the body. When the customer or employee desires to remove an item, they may simply retract the body into the housing in a manner similar to that described above, and retrieve the desired product(s). This embodiment may be especially useful for retail stores where heavy, fragile or otherwise dangerous items are stored and prone to falling from the shelves (e.g., hardware retail stores).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It, will also be appreciated that the features described in connection with individual embodiments may be shared with others of the described embodiments.

What is claimed is:

1. A retractable safety restraint device comprising:
an inner core;
a spring disposed around the inner core and having a relaxed condition and an stretched condition;
an outer shaft disposed around the spring;
a housing disposed around the outer shaft, the outer shaft being rotatable within the housing;
a moveable member translatable relative to the housing; and
a body coupled to the outer shaft at a first end, and to the moveable member at a second end, the body having a length from the first end to the second end, and a width perpendicular to its length, the width of the body being approximately equal to a height of the housing, the body being wrapped around the outer shaft when the spring is in the relaxed condition.

2. The retractable safety restraint device of claim 1, wherein the body includes a netting having a plurality of apertures.

3. The retractable safety restraint device of claim 1, wherein the body includes a canvas.

4. The retractable safety restraint device of claim 1, wherein the body includes a translucent material.

5. The retractable safety restraint device of claim 1, further comprising at least one clamp coupled to the housing.

6. The retractable safety restraint device of claim 1, further comprising at least one connector coupled to the moveable member.

7. The retractable safety restraint device of claim 1, further comprising a handle coupled to the moveable member.

8. The retractable safety restraint device of claim 1, wherein the housing is substantially cylindrical and includes an elongated slit through which the body is able to pass.

9. The retractable safety restraint device of claim 1, further comprising a gear coupled to the inner core, and a wheel coupled to the gear and disposed outside of the housing.

10. The retractable safety restraint device of claim 9, wherein the wheel is configured and arranged to create tension in the body by pulling the body within the housing.

11. The retractable safety restraint device of claim 1, further comprising a depressable locking pin disposed on one side of the housing, and wherein depressing the locking pin prevents the outer shaft from rotating within the housing.

12. The retractable safety restraint device of claim 1, wherein the body has a length of between 2 feet and 60 feet, and a width of between 2 feet and 3 feet.

13. The retractable safety restraint device of claim 1, wherein the safety restraint device is configured for use within a storage compartment, and the body is configured to stretch along a length or a width of the storage compartment.

14. The retractable safety restraint device of claim 1, wherein the safety restraint device is configured for use within a storage compartment and the body is configured to stretch diagonally across the storage compartment.

15. The retractable safety restraint device of claim 1, wherein the safety restraint device is configured for use within a storage compartment and a width of the body is substantially equal to a height of the storage compartment.

16. A transportation system comprising:
a storage compartment; and
a retractable safety restraint device including an inner core, a spring disposed around the core and having a relaxed condition and an stretched condition, an outer shaft disposed around the spring, a housing disposed around the outer shaft, the outer shaft being rotatable within the housing, a moveable member translatable relative to the housing, and a body coupled to the outer shaft at a first end, and to the moveable member at a second end, the body having a length from the first end to the second end, and a width perpendicular to its length, the width of the body being approximately equal to a height of the housing, the body being wrapped around the outer shaft when the spring is in the relaxed condition.

17. The system of claim 16, wherein the body includes a netting having a plurality of apertures.

18. The system of claim 16, wherein the body includes a canvas.

19. The system of claim 16, wherein the body includes a translucent material.

20. The system of claim 16, further comprising at least one clamp coupled to the housing, and at least one track coupled to the storage compartment, the at least one track having apertures for mating with the clamp.
